(19) United States
(12) Patent Application Publication
(10) Pub. No.: US 2025/0322096 A1
(43) Pub. Date: Oct. 16, 2025

(54) REAL-TIME, ACCESS-CONTROLLED INTERFACE FOR VIEWING METADATA

(71) Applicant: Snowflake Inc., Bozeman, MT (US)

(72) Inventors: Dhiraj Gupta, San Mateo, CA (US); Justin Min, Menlo Park, CA (US); Subramanian Muralidhar, Mercer Island, WA (US); Tao Wan, Mountain View, CA (US)

(21) Appl. No.: 18/633,840

(22) Filed: Apr. 12, 2024

(51) Int. Cl. G06F 21/62; G06F 16/25

(52) U.S. Cl. CPC G06F 21/6227; G06F 16/258

(57) ABSTRACT

Techniques for providing an interface for viewing real-time metadata stored in different locations and in different formats are described. A monitoring schema may process queries related to user metadata using the techniques described below in further detail. The monitoring schema may also provide a single interface with fine-grain access control for viewing metadata based on role-based access control with limitless retention using different storage locations.

### TECHNICAL FIELD

The present disclosure generally relates to data systems, such as data warehouses, and, more specifically, to interfaces for viewing metadata.

### BACKGROUND

Data systems, such as data warehouses, may be provided through a cloud platform, which allows organizations and users to store, manage, and retrieve data from the cloud. In addition to customer business data in source tables, customers may wish to store metadata along with the source tables. This metadata can be first stored in a metadata database, but customers typically also like the metadata to be stored in the data warehouse so that it can be easily accessed. Having metadata stored in a plurality of locations can make accessing and viewing the metadata difficult.

### BRIEF DESCRIPTION OF THE DRAWINGS

Various ones of the appended drawings merely illustrate example embodiments of the present disclosure and should not be considered as limiting its scope.

FIG. 1 illustrates an example computing environment, according to some example embodiments.

FIG. 2 is a block diagram illustrating components of a compute service manager, according to some example embodiments.

FIG. 3 is a block diagram illustrating components of an execution platform, according to some example embodiments.

FIG. 4 shows an example of a computing environment used for transferring metadata, according to some example embodiments.

FIG. 5 shows a flow diagram for a method for exporting data, according to some example embodiments.

FIG. 6 is a simplified block diagram of system for automated data ingestion, according to some example embodiments.

FIG. 7 is a schematic block diagram of a process of ingesting data into a database, according to some example embodiments.

FIG. 8 shows a flow diagram for a method for querying metadata in different locations, according to some example embodiments.

FIG. 9 shows a flow diagram for a method for enforcing access control for queried metadata from different locations, according to some example embodiments.

FIG. 10 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Described herein are techniques for providing an interface for viewing real-time metadata stored in different locations and in different formats. A monitoring schema may process queries related to user metadata using the techniques described below in further detail. The monitoring schema may also provide a single interface with fine-grain access control for viewing metadata based on role-based access control with limitless retention using different storage locations. The techniques overcome technical limitations of conventional approaches including retention limits, output limits, and lack of access control.

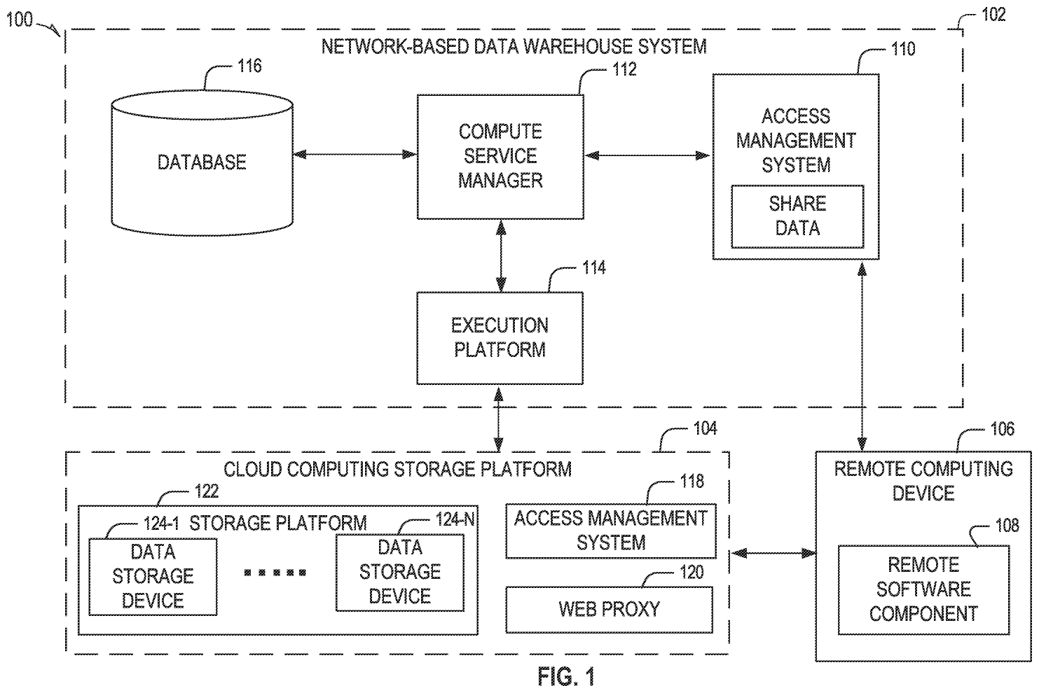

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102, a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. While in the embodiment illustrated in FIG. 1, a data warehouse is depicted, other embodiments may include other types of databases or other data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures.

The network-based database system 102 comprises an access management system 110, a compute service manager 112, an execution platform 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

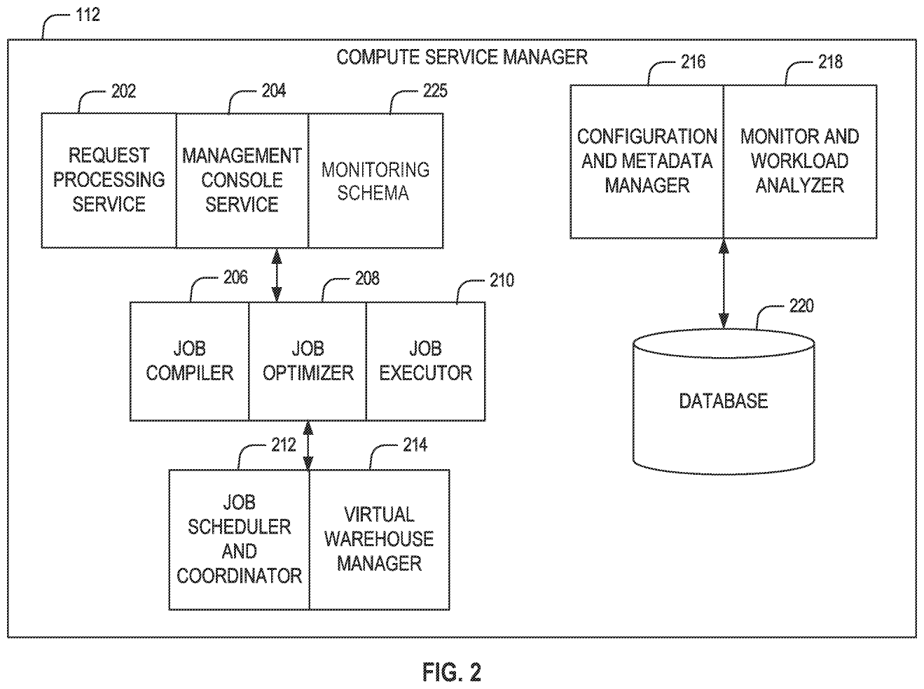

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represent any data storage device within the network-based database system 102. For example, data storage device 220 may represent caches in execution platform 114, storage devices in cloud computing storage platform 104, or any other storage device.

As described in further detail below, a monitoring schema 225 provides an interface for viewing real-time metadata stored in different locations and in different formats. The monitoring schema 225 may process queries related to user metadata using the techniques described below in further detail. The monitoring schema 225 may also provide fine grain access control for viewing metadata based on role based access control with limitless retention using different storage locations.

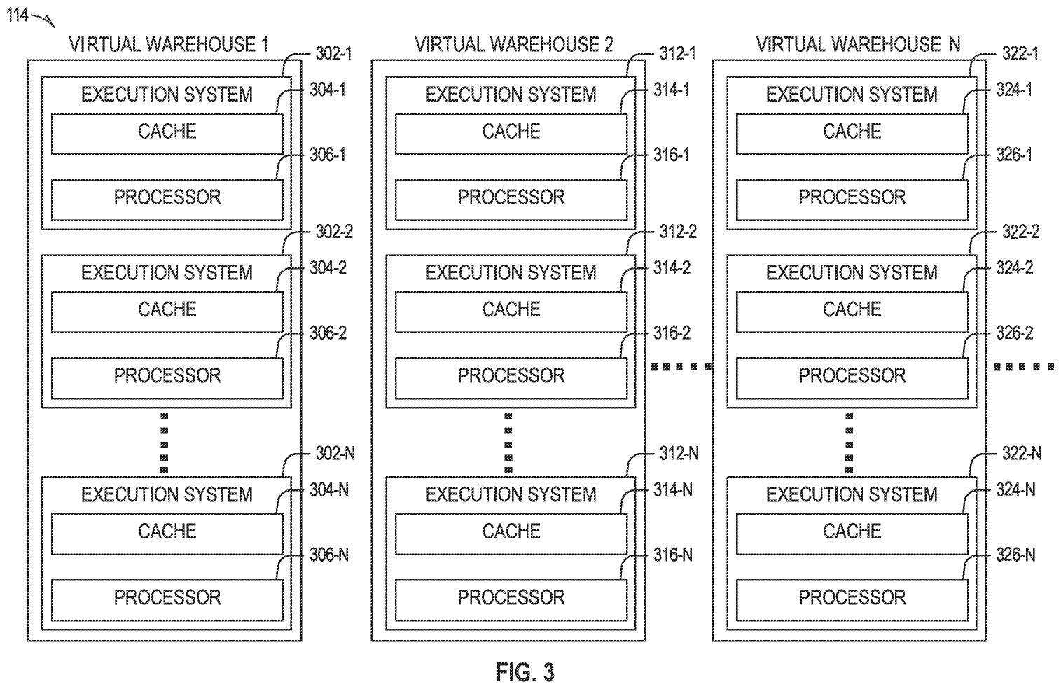

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2, and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

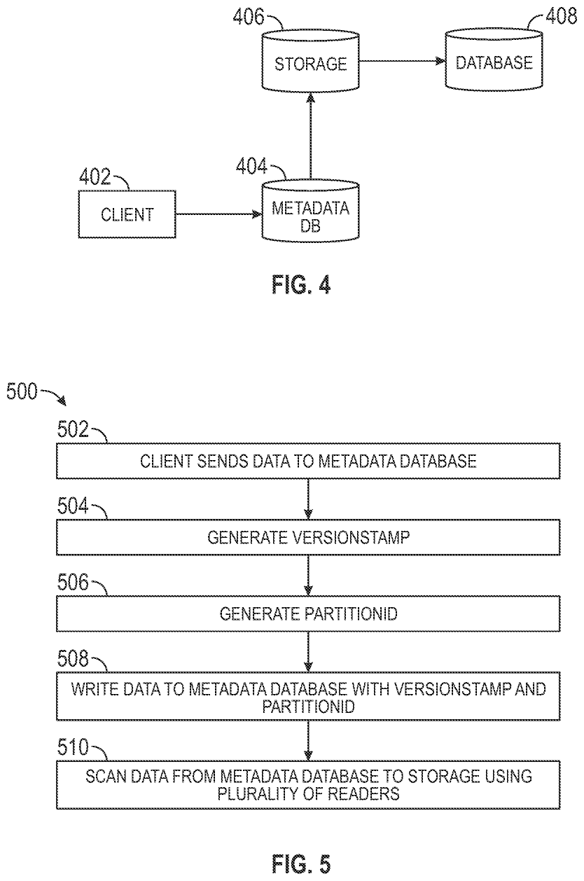

As mentioned above, a table may have associated metadata (e.g., metadata manager 216). Metadata for a table may be uploaded to a database storing the table separately from the table data. FIG. 4 shows an example of a computing environment used for transferring metadata, according to some example embodiments. The computing environment may include a client 402, a metadata database 404, a storage 406, and a database 408.

The client 402 may be implemented as a remote computing device as described above (e.g., remote software component 108). The client 402 may write metadata for one or more tables in the metadata database 404. The metadata may be stored in the metadata database 404. The metadata database may be provided as a transactional database (e.g., FoundationDB (FDB)) and includes key-value stores.

The metadata may be exported from the metadata database 404 to the storage 406. The storage 406 may be provided as cloud storage. In some embodiments, the storage 406 may be a part of the data system. For example, the cloud storage may be provided as a S3 bucket in as part of Amazon Web Services™.

The metadata may then be transferred from the storage 406 to the database 408. The database 408 may also store the table to which the metadata pertains. Moreover, the metadata is then combined with the other metadata for the corresponding table in the database 408. The database 408 may be stored using remote data storage devices (e.g., data storage devices 124-1 to 124-N) in the data system, as described above.

Each of these steps relating to the storing and moving of the metadata can be complex and lead to latency and reliability issues. For example, in some conventional systems, data from the metadata database 404 is scanned periodically (e.g., every 15 minutes, 1 hour, etc.) to be written to the storage 406. This periodic scanning can increase latency and can lead to reliability issues. For example, the periodic scanning is typically performed based on a wall clock time for when the data is originally written to the metadata database 404. That is, the data written in each epoch time (e.g., last 15 minutes, last 1 hour, etc.) is scanned to be exported. However, clock skew can cause data written at the boundaries to be lost. Moreover, this periodic scanning is typically done by a single reader and large sets to scanned can lead to latency issues.

Next, techniques for improved data exporting from the metadata database 404 to storage 406 are described below. FIG. 5 shows a flow diagram for a method 500 for exporting data, according to some example embodiments. In an example, portions of the method 500 can be performed by the client 402, metadata database 404 and storage 406 as described above with reference to FIG. 4. At operation 502, the client may send metadata to the metadata database. For example, a customer may create a new named “table 5” for account 1, and this information may be sent to the metadata database.

At operation 504, a version stamp (also referred to as VersionStamp) may be generated and assigned for the new data. For example, the VersionStamp may be generated by the metadata database 404. The VersionStamp may be based on a monotonic increasing register. That is, each piece of new data (e.g., slice of data persistence object (DPO)) when written to the metadata database caused the VersionStamp register to increase in value and that VersionStamp value is assigned to the new data. For example, if data A was written to the metadata database and it was assigned VersionStamp value 7. The next data written to the metadata database (say, data B) would be assigned VersionStamp value 8, and the next data written to the metadata database after that (say, data C) would be assigned VersionStamp value 9, and so on.

The VersionStamp values may not be specific or related to any attributes of the data (e.g., account, table, etc.). Hence, the VersionStamp may be independent of the type of data and can be used as a reference point for exporting data without the reliability issues associated with using a timestamps based on wall clock subject to clock skew, as described above.

At operation 506, a partitionID may be generated and assigned for the new data. For example, the partitionID may be generated by the metadata database 404. A maximum number of partitions may be set (e.g., 16, 32, etc.) and each piece of new data (e.g., slice of DPO) may be assigned a partition from the maximum number of partitions. The paritionID may separate incoming data into sets (or partitions) of data.

The partitionID may be implemented as a function of attributes of the new data. In some embodiments, the partitionID may be a function of the data identification (e.g., tableID) and the account identification (e.g., accountID). For example, the partitionID may be generated based on hashing the relevant attributes modular divided by the number of maximum partitions (i.e., modular). In one example, the parititonID may be generated using data identification and account identification as follows:

partitionID=hash(tableID,accountID)%(maximum number of partitions)

At operation 508, the received data with the assigned VersionStamp and partitionID may be written to the metadata database. For example, a writer component may write this information to the metadata database where it is stored. A plurality of writers (e.g., writer computing resources) may be provided, and writers may be assigned based on the partitionID. The writing of the data may be done at the same time as the assignment of the VerstionStamp and/or partitionID. For example, the VersionStamp may be based on the time the data was written to the metadata database.

At operation 510, a plurality of readers (e.g., reader computing resources) may scan stored metadata in the metadata database to write the data into storage, such as cloud storage, based on the partitionID and VersionStamp. In some embodiments, the readers may perform the scan periodically (say, every 5 seconds) at a faster rate than conventional systems and scan the most current data stored in the metadata database based on the VersionStamps. For example, in a first scan, the readers may scan new data up to a specific VersionStamp, say x. In the next scan, the readers scan new data with VersionStamps starting from x+1 to y, and the next scan after that may scan new data with VersionStamps starting from y+1 and so on. The use of VersionStamps, which are monotonically increased, reduces the risk of skipping data as compared to techniques that use timestamp due to clock drift issues mentioned above and allows scanning to be done at more frequent intervals, reducing latency issues.

Moreover, the use of partitionIDs allow multiple readers to scan stored data in parallel. A reader may be assigned one or more non-overlapping partitions to scan. For example, a reader may be assigned one partition, such that the number of readers equals the number of partitions. In some embodiments, a reader may be assigned a plurality of partitions, such that the number of readers is less than the number of partitions.

A mapping of partitions to readers may be assigned. For example, the partition-to-reader mapping can be implemented as follows:

reader-id=mod(partitionID,number of readers)

Flexibility and dynamic allocation of readers and partitions may also be implemented. The number of partitions and/or number of readers can be changed dynamically.

Referring back to FIG. 4, the next step in the transfer of the metadata is from the storage 406 to the database 408. Some conventional techniques use a “copy” command for this transfer. The “copy” command is typically manually performed or performed based on a set schedule (say, every 15 minutes). However, the use of such “copy” commands can add more latency.

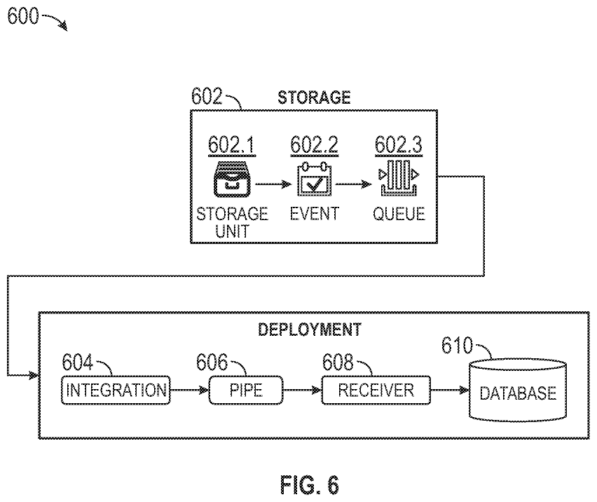

Thus, this data transfer from the storage 406 to the database 408 may be improved by implementing auto-ingestion techniques, as described in further detail below. FIG. 6 is a simplified block diagram of system 600 for automated data ingestion, according to some example embodiments. The system may include a storage 602, which may be provided as cloud storage (e.g., storage 406). The storage 602 may include data that has been exported from a metadata database using the techniques described above.

The storage 602 may store data (or files) from the metadata database to be ingested into a database 610. In some embodiments, the storage 602 may include a storage unit 602.1, an event block 602.2, and a queue 602.3. The system may also include a deployment to ingest data in the database 610. The deployment may be communicatively coupled to the queue 602.3, and may include an integration 604, a pipe 606, and a receiver 608.

Integration 604 may be configured to receive a notification when new data becomes available in queue 602.3. For example, the queue may include a pool of Simple Queue Service™ (SQS) queues as part of an Amazon Web Services™ S3 bucket. The pool of SQS queues may be provided to client accounts to add user files to a bucket. A notification may be automatically generated when one or more user files are added to a client account data bucket. A plurality of customer data buckets may be provided for each client account. The automatically generated notification may be received by the integration 604.

For example, the integration 604 may provide information relating to an occurrence of an event in the queue 602.3. Events may include creation of new data, update of old data, and deletion of old data. The integration 604 may also provide identification information for a resource associated with the event, e.g., the user file that has been created, updated, or deleted. The integration 604 may communicate with the queue 602.3 because the integration 604 may be provided with credentials for the queue 602.3, for example by an administrator and/or user. In an embodiment, the integration 604 may poll the queue 602.3 for notifications.

The integration 604 may deliver the notification to the pipe 606, which may be provided as a single pipe or multiple pipes. The pipe 606 may store information relating to what data and the location of the data for automatic data ingestion related to the queue 602.3. The receiver 608 may perform the automated data ingestion, and then store the ingested data in the database 610.

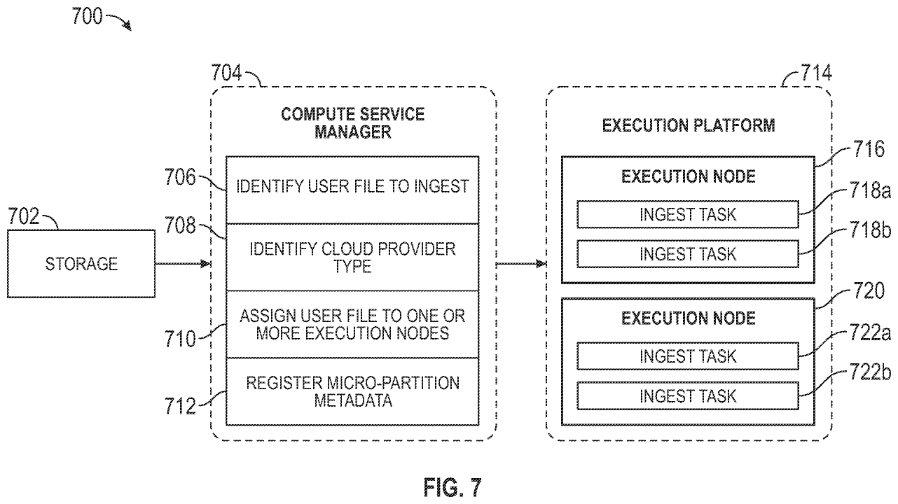

FIG. 7 is a schematic block diagram of a process 700 of ingesting data into a database, according to some example embodiments. The process 700 begins and a storage 702 sends an ingest request, such as a notification. The storage 702 may directly or indirectly communicate with the database system to send in the ingest request. In some embodiments, the ingest request is a notification provided by a third-party vendor storage account, or the ingest request may arise from a compute service manager polling a data lake associated with the client account to determine whether any user files have been added to the client account that have not yet been ingested into the database. The notification includes a list of files to insert into a table of the database. The files are persisted in a queue specific to the receiving table of the database.

The ingest request is received by a compute service manager 704. The compute service manager 704 identifies at step 706 a user file to ingest. At step 708, the compute service manager identifies a cloud provider type associated with the client account. At step 710, the compute service manager 704 may assign the user file to one or more execution nodes, based at least in part on the detected cloud provider type, and registers at step 712 micro-partition metadata associated with a database table after the file is ingested into a micro-partition of the database table. The compute service manager 704 provisions one or more execution nodes 716, 720 of an execution platform 714 to perform one or more tasks associated with ingesting the user file. Such ingest tasks 718a, 718b, 722a, 722b include, for example, cutting a file into one or more sections, generating a new micro-partition based on the user file, and/or inserting the new micro-partition in a table of the database.

The process 700 begins an IngestTask that will run on a warehouse. The IngestTask will pull user files from the queue for a database table until it is told to stop doing so. The IngestTask will periodically cut a new user file and add it to the database table. In one embodiment, the ingest process is “serverless” in that it is an integrated service provided by the database or compute service manager 704. That is, a user associated with the client account need not provision its own warehouse or a third-party warehouse in order to perform the ingestion process. For example, the database or database provided (e.g., via instances of the compute service manager 704) may maintain the ingest warehouse that then services one or more or all accounts/customers of the database provider.

In some embodiments, there may be more than one IngestTask pulling from a queue for a given table, and this might be necessary to keep up with the rate of incoming data. In some embodiments, the IngestTask may decide the time to cut a new file to increase the chances of getting an ideal sized file and avoid “odd sized” files that would result if the file size was line up with one or more user files. This may come at the cost of added complexity as the track line number of the files consumed must be tracked.

As described above, the metadata can be stored in different locations, such as the metadata database 404 and database 408. Moreover, the metadata may be stored in different formats in the different locations. For example, metadata in the metadata database 404 can be stored in a first format suitable for a transactional database. The first format may be a compressed file format. Metadata in the database 408 can be stored in a second format, such as a proprietary format of the data system in which database 408 is stored. The different storage locations of the metadata may have different capacity and processing limits. For example, the metadata database 404 can have a maximum output limit of the number of rows that can be outputted in response to a single query (e.g., 10,000 rows). Therefore, having metadata in different locations can hinder accessing the metadata in real-time. Next, techniques for providing a real-time, access-controlled interface for viewing metadata (e.g., monitoring schema 225) are described.

The interface can provide a single interface for viewing metadata stored in different locations and different formats. For example, the interface can retrieve relevant metadata stored in the metadata database 404 in a first format and the database 408 in a second format. The interface may convert the retrieved metadata into a common format and combine the metadata from the different locations providing the user a single interface for viewing and accessing the metadata.

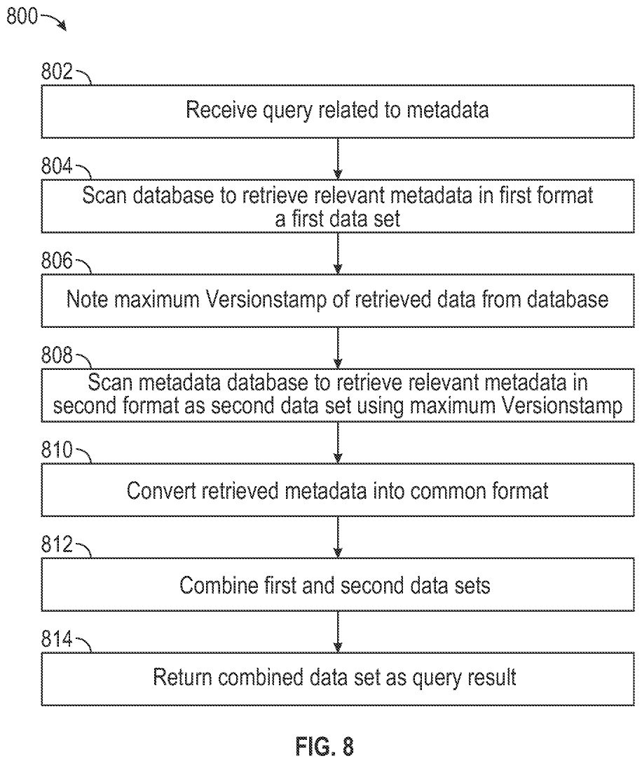

FIG. 8 shows a flow diagram for a method 800 for querying metadata in different locations, according to some example embodiments. In this example, metadata can be stored in two different locations: metadata database 404 for more recently generated metadata and database 408 for older metadata that has been ingested from the metadata database 404 using the techniques described herein. The metadata can be stored using VersionStamps, as described herein.

At operation 802, a query from a user related to metadata of the user is received. For example, a compute service manager (e.g., compute service manager 112 described above) in the data system may receive the query and generate query plan to execute the query. The compute service manager may then utilize one or more execution platforms (e.g., execution platform 114) to execute the query plan.

At operation 804, database 408 is scanned to retrieve relevant metadata for the query from the database 408. For example, one or more execution platforms may scan the database 408 based on the query plan to retrieve the relevant metadata for the query from the database 408. The retrieved metadata from the database 408 (e.g., first dataset) may be in a second format, such as a proprietary format of the data system.

At operation 806, the maximum VersionStamp of the retrieved metadata from the database 408 is recorded. For example, the one or more execution platforms may record the maximum VersionStamp in a register.

At operation 808, the metadata database 404 is scanned to retrieve the relevant metadata for the query from the metadata database 404 using the maximum VersionStamp as the lower bound. For example, one or more execution platforms may scan the metadata database 404 based on the query plan to retrieve the relevant metadata for the query from the metadata database 404 using the maximum VersionStamp as the lower bound. Therefore, metadata ingested into the database 408 but still also stored in the metadata database 404 is not retrieved in duplication. The retrieved metadata from the metadata database 404 (e.g., second dataset) may be in a first format, such as an optimized format for a transactional database.

In some embodiments, the same set of one or more execution platforms may be used for scanning the database 408 and the metadata database 404. In some embodiments, the user may have a larger virtual warehouse, and different sets of one or more execution platforms can be used to scan the database 408 and the metadata database 404.

At operation 810, the retrieved metadata from the database 408 and metadata database 404 is converted into a common format. The common format may be a human readable format.

At operation 812, the converted first data set and second data set are combined. For example, the one or more execution platforms may execute a “union-all” command to combine the two data sets. The “union-all” command combines two data sets without de-duplication as compared to a “union” command that combines two data sets with de-duplication of duplicate rows. Because the first data set and second data set were retrieved using VersionStamps, no de-duplication is needed and the “union-all” command can be used. The use of more straightforward combining techniques, such as using “union-all” commands, improves performance and speed.

At operation 814, the combined data set is returned to the user as query results.

The interface for viewing metadata may also enforce role-based access control (RBAC). Access privileges to data can be provided using RBAC grants. However, RBAC grants can be maintained at different storage locations.

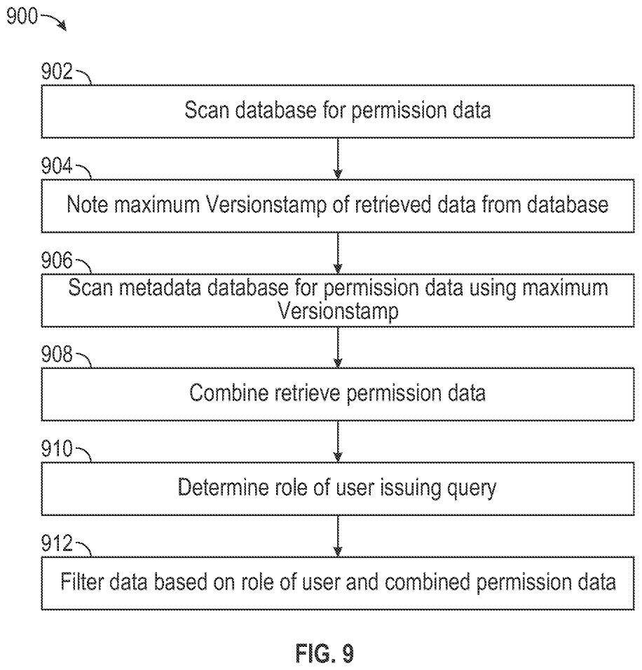

FIG. 9 shows a flow diagram for a method 900 for enforcing access control for queried metadata from different locations, according to some example embodiments. In this example, metadata can be stored in two different locations: metadata database 404 for more recently generated metadata and database 408 for older metadata that has been ingested from the metadata database 404 using the techniques described herein. Also, method 900 may be executed in conjunction with executing a query for metadata in the different locations using the method 800 described above with reference to FIG. 8.

At operation 902, database 408 is scanned for permission data related to table(s) referred to in the query. For example, one or more execution platforms may scan the database 408 for permission data. The permission data includes grant privileges for specified data to certain user roles.

At operation 904, the maximum VersionStamp of the retrieved permission data from the database 408 is recorded, for example, by the one or more execution platforms.

At operation 906, metadata database 404 is scanned for permission data related to table(s) referred to in the query using the maximum VersionStamp as the lower bound. For example, one or more execution platforms may scan the metadata database 404 for permission data using the maximum VersionStamp as the lower bound. The permission data includes grant privileges for specified data to certain user roles. using the maximum. By using the maximum VersionStamp as the lower bound, permission data stored in the database 408 but still also stored in the metadata database 404 is not retrieved in duplication.

At operation 908, the permission data retrieved from the database 408 and metadata database 404 is combined. If there is a conflict in the two sets of permission data, then the permission data from the metadata database 404 is given precedent and used since it is newer. For example, if permission data retrieved from the database 408 indicates that the user roles “a” and “b” have access to a table, but the permission data retrieved from the metadata database 404 indicates that only user role “a” has access to the table, then the permission data from the metadata database 404 indicating that only user role “a” has access is used.

At operation 910, the role of the user who issued the query is determined.

At operation 912, the retrieved metadata (e.g., rows) in response to the query (e.g., method 800) is filtered based on the determined role of the user who issued the query and the combined permission data. For example, rows where the query-issuer does not have permission to view can be filtered out (i.e., removed).

As mentioned above, some storage locations may have output limits. For example, the metadata database 404 may have a maximum output limit for query results. That is, the output of a query cannot exceed the maximum output limit (e.g., 10,000 rows). If a query result exceeds the maximum output limit, the results may be truncated, and the user may not have access to the full results. However, mechanisms can be used to mitigate against exceeding the maximum output limit. In some examples, the ingestion frequency of ingesting metadata from the metadata database 404 to the database 408, as described above, may be increased so that the maximum output limit for the metadata database 404 is not reached during the ingestion interval. In some examples, data written to the metadata database 404 may be throttled so that the maximum output limit is not reached during the ingestion interval.

As mentioned above, respective rows of the metadata are associated with VersionStamps, which may be based on a monotonic increasing register. The rows may also be associated with a timestamps based on a wall clock for when the data is written. Therefore, a user may issue a query using a timestamp value, such as list of tables written between time “x” and “y”. The system can use both the VersionStamp and timestamp values to generate the results of the query by retrieving data from different locations. For example, data may be retrieved from the database 408 based on a first timestamp value (e.g., “x”) and maximum VersionStamp in the database 408. Data may then be retrieved from the metadata database 408 based on the maximum VersionStamp as the lower bound and the second timestamp value (e.g., “y”) as the higher bound.

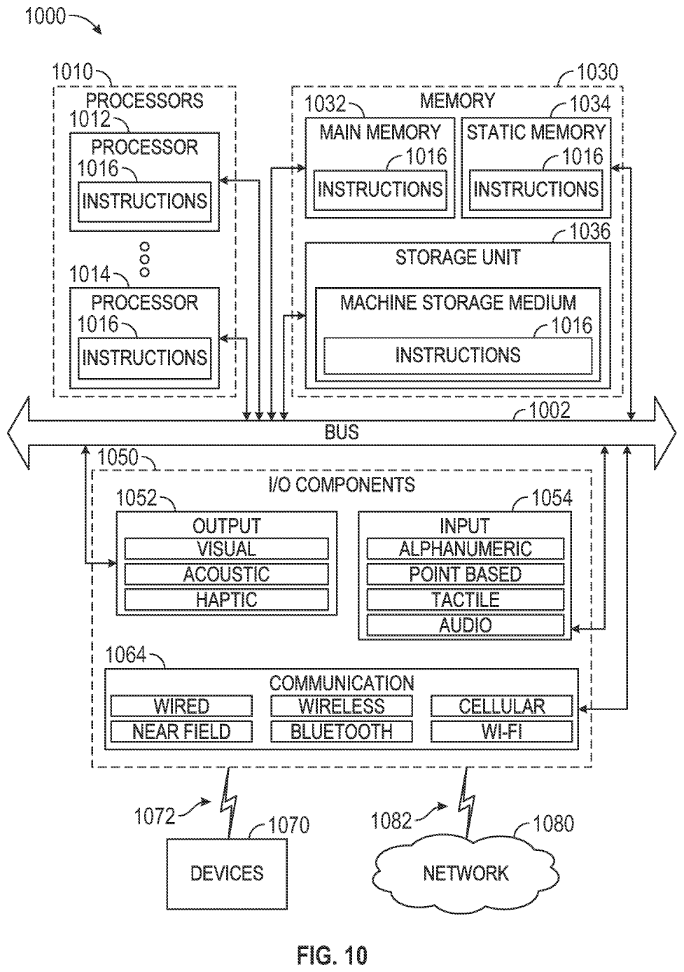

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example, the instructions 1016 may cause the machine 1000 to execute any one or more operations of any one or more of the methods described herein. As another example, the instructions 1016 may cause the machine 1000 to implement portions of the data flows described herein. In this way, the instructions 1016 transform a general, non-programmed machine into a particular machine 1000 (e.g., the remote computing device 106, the access management system 118, the compute service manager 112, the execution platform 114, the access management system 110, the Web proxy 120, remote computing device 106) that is specially configured to carry out any one of the described and illustrated functions in the manner described herein.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 includes processors 1010, memory 1030, and input/output (I/O) components 1050 configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors 1010 that may comprise two or more independent processors (sometimes referred to as “cores”) that may execute instructions 1016 contemporaneously. Although FIG. 10 shows multiple processors 1010, the machine 1000 may include a single processor with a single core, a single processor with multiple cores (e.g., a multi-core processor), multiple processors with a single core, multiple processors with multiple cores, or any combination thereof.

The memory 1030 may include a main memory 1032, a static memory 1034, and a storage unit 1036, all accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 include components to receive input, provide output, produce output, transmit information, exchange information, capture measurements, and so on. The specific I/O components 1050 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, and other communication components to provide communication via other modalities. The devices 1070 may be another machine or any of a wide variety of peripheral devices (e.g., a peripheral device coupled via a universal serial bus (USB)). For example, as noted above, the machine 1000 may correspond to any one of the remote computing device 106, the access management system 118, the compute service manager 112, the execution platform 114, the access management system 110, the Web proxy 120, and the devices 1070 may include any other of these systems and devices.

The various memories (e.g., 1030, 1032, 1034, and/or memory of the processor(s) 1010 and/or the storage unit 1036) may store one or more sets of instructions 1016 and data structures (e.g., software) embodying or utilized by any one or more of the methodologies or functions described herein. These instructions 1016, when executed by the processor(s) 1010, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1080 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.

Example 1. A method comprising: receiving, by a network-based data system, a query related to metadata, the metadata being stored in a first storage location and a second storage location using version stamps, each of the version stamps comprising a register value corresponding to an order the metadata was written into the first storage location; scanning, by at least one hardware processor, the second storage location to retrieve relevant metadata for the query to generate a first data set; recording a maximum version stamp value in the first data set; scanning the first storage location to retrieve relevant metadata for the query using the maximum version stamp value as a lower bound to generate a second data set; combining the first data set and the second data set to generate a combined data set; and outputting the combined data set as a result of the query.

Example 2. The method of example 1, wherein metadata written into the first storage location is ingested into the second storage location.

Example 3. The method of any of examples 1-2, wherein the first data set is provided in a first format and the second data set is provided in a second format, the method further comprising: converting the first data set into a common format; and converting the second data set into the common format, wherein the combined data set is in the common format.

Example 4. The method of any of examples 1-3, wherein the first storage location is a transactional database in the data system, and wherein the second storage location is a database stored in a plurality of storage devices in the data system.

Example 5. The method of any of examples 1-4, wherein the combining is performed using a union-all command.

Example 6. The method of any of examples 1-5, further comprising: scanning the second storage location for a first set of permission data; scanning the first storage location for a second set of permission data using the maximum version stamp value; and combining the first set of permission data and the second set of permission data to generate a combined set of permission data.

Example 7. The method of any of examples 1-6, further comprising: determining a role of a user who issued the query; and filtering out at least one row in the combined data set based on the role of the user and the combined set of permission data.

Example 8. A system comprising: one or more processors of a machine; and a memory storing instructions that, when executed by the one or more processors, cause the machine to perform operations implementing any one of example methods 1 to 7.

Example 9. A machine-readable storage device embodying instructions that, when executed by a machine, cause the machine to perform operations implementing any one of example methods 1 to 7.

What is claimed is:

1. A method comprising:
receiving, by a network-based data system, a query related to metadata, the metadata being stored in a first storage location and a second storage location using version stamps, each of the version stamps comprising a register value corresponding to an order the metadata was written into the first storage location;
scanning, by at least one hardware processor, the second storage location to retrieve relevant metadata for the query to generate a first data set;
recording a maximum version stamp value in the first data set;
scanning the first storage location to retrieve relevant metadata for the query using the maximum version stamp value as a lower bound to generate a second data set;
combining the first data set and the second data set to generate a combined data set; and
outputting the combined data set as a result of the query.

2. The method of claim 1, wherein metadata written into the first storage location is ingested into the second storage location.

3. The method of claim 1, wherein the first data set is provided in a first format and the second data set is provided in a second format, the method further comprising:
converting the first data set into a common format; and
converting the second data set into the common format, wherein the combined data set is in the common format.

4. The method of claim 1, wherein the first storage location is a transactional database in the data system, and wherein the second storage location is a database stored in a plurality of storage devices in the data system.

5. The method of claim 1, wherein the combining is performed using a union-all command.

6. The method of claim 1, further comprising:
scanning the second storage location for a first set of permission data;
scanning the first storage location for a second set of permission data using the maximum version stamp value; and
combining the first set of permission data and the second set of permission data to generate a combined set of permission data.

7. The method of claim 6, further comprising:
determining a role of a user who issued the query; and
filtering out at least one row in the combined data set based on the role of the user and the combined set of permission data.

8. A machine-storage medium embodying instructions that, when executed by a machine, cause the machine to perform operations comprising:
receiving, by a network-based data system, a query related to metadata, the metadata being stored in a first storage location and a second storage location using version stamps, each of the version stamps comprising a register value corresponding to an order the metadata was written into the first storage location;
scanning the second storage location to retrieve relevant metadata for the query to generate a first data set;
recording a maximum version stamp value in the first data set;
scanning the first storage location to retrieve relevant metadata for the query using the maximum version stamp value as a lower bound to generate a second data set;
combining the first data set and the second data set to generate a combined data set; and
outputting the combined data set as a result of the query.

9. The machine-storage medium of claim 8, wherein metadata written into the first storage location is ingested into the second storage location.

10. The machine-storage medium of claim 8, wherein the first data set is provided in a first format and the second data set is provided in a second format, the operations further comprising:
converting the first data set into a common format; and
converting the second data set into the common format, wherein the combined data set is in the common format.

11. The machine-storage medium of claim 8, wherein the first storage location is a transactional database in the data system, and wherein the second storage location is a database stored in a plurality of storage devices in the data system.

12. The machine-storage medium of claim 8, wherein the combining is performed using a union-all command.

13. The met machine-storage medium hod of claim 8, further comprising:
scanning the second storage location for a first set of permission data;
scanning the first storage location for a second set of permission data using the maximum version stamp value; and
combining the first set of permission data and the second set of permission data to generate a combined set of permission data.

14. The machine-storage medium of claim 13, further comprising:
determining a role of a user who issued the query; and
filtering out at least one row in the combined data set based on the role of the user and the combined set of permission data.

15. A system comprising:
at least one hardware processor; and
at least one memory storing instructions that, when executed by the at least one hardware processor, cause the at least one hardware processor to perform operations comprising:
receiving, by a network-based data system, a query related to metadata, the metadata being stored in a first storage location and a second storage location using version stamps, each of the version stamps comprising a register value corresponding to an order the metadata was written into the first storage location;
scanning the second storage location to retrieve relevant metadata for the query to generate a first data set;
recording a maximum version stamp value in the first data set;
scanning the first storage location to retrieve relevant metadata for the query using the maximum version stamp value as a lower bound to generate a second data set;
combining the first data set and the second data set to generate a combined data set; and
outputting the combined data set as a result of the query.

16. The system of claim 15, wherein metadata written into the first storage location is ingested into the second storage location.

17. The system of claim 15, wherein the first data set is provided in a first format and the second data set is provided in a second format, the operations further comprising:
converting the first data set into a common format; and
converting the second data set into the common format, wherein the combined data set is in the common format.

18. The system of claim 15, wherein the first storage location is a transactional database in the data system, and wherein the second storage location is a database stored in a plurality of storage devices in the data system.

19. The system of claim 15, wherein the combining is performed using a union-all command.

20. The system of claim 15, the operations further comprising:
scanning the second storage location for a first set of permission data;
scanning the first storage location for a second set of permission data using the maximum version stamp value; and
combining the first set of permission data and the second set of permission data to generate a combined set of permission data.

21. The system of claim 20, the operations further comprising:
determining a role of a user who issued the query; and
filtering out at least one row in the combined data set based on the role of the user and the combined set of permission data.
